(19) United States
(12) Patent Application Publication
(10) Pub. No.: US 2026/0136194 A1
(43) Pub. Date: May 14, 2026

(54) Secure Mobile Communication

(71) Applicant: Bank of America Corporation, Charlotte, NC (US)

(72) Inventors: Mary Anne Conner, Charlotte, NC (US); Shiby Parayil, Frisco, TX (US); Mahendra Patoliya, Frisco, TX (US); James Harry Dyer, Charlotte, NC (US); Tiara Rurey Fry, Charlotte, NC (US); Guy Vernon Pearson, JR., Columbia, MD (US); Marlo A. Wilson, Charlotte, NC (US); Czarina McGregor, Matthews, NC (US)

(21) Appl. No.: 18/945,668

(22) Filed: Nov. 13, 2024

(51) Int. Cl. H04W 12/122; H04W 12/60; H04W 12/80

(52) U.S. Cl. CPC H04W 12/122; H04W 12/66; H04W 12/80

(57) ABSTRACT

Arrangements for providing secure mobile communications are provided. In some examples, a computing platform may receive or intercept an incoming call to a mobile device. In some examples, the call may be routed, via a wireless data network, to an internal cybersecurity evaluation system that may, e.g., be part of the computing platform. The computing platform may evaluate the call to determine a likelihood that the call is malicious. If it is determined that the call is likely malicious, the call may be routed to an internet entity computing device for further analysis, intelligence gathering, or the like. If the call is not likely malicious, the call may be routed, via the data network, to the intended mobile device and may be provided to the mobile device via an application executing on the mobile device.

### BACKGROUND

Aspects of the disclosure relate to electrical computers, systems, and devices for secure mobile communication.

Current arrangements for mobile communications rely on cellular carriers to evaluate calls for malicious content (e.g., spam, social engineering, and the like). Generally, cellular networks and carriers have limited ability to detect potentially malicious calls and limited, if any, ability to mitigate risk associated with those calls. Accordingly, as discussed herein, it would be advantageous to provide infrastructure, internal to an organization, through which mobile device calls are routed and evaluated for potential malicious content.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with provide secure mobile communications.

In some examples, a computing platform may receive or intercept an incoming call to a mobile device. In some examples, the call may be routed, via a wireless data network, to an internal cybersecurity evaluation system that may, e.g., be part of the computing platform. The computing platform may evaluate the call to determine a likelihood that the call is malicious. If it is determined that the call is likely malicious, the call may be routed to an internet entity computing device for further analysis, intelligence gathering, or the like. If the call is not likely malicious, the call may be routed, via the data network, to the intended mobile device and may be provided to the mobile device via an application executing on the mobile device.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for implementing secure mobile communications in accordance with one or more aspects described herein;

FIGS. 2A-2C depict an illustrative event sequence for secure mobile communications in accordance with one or more aspects described herein;

FIG. 3 illustrates an illustrative method for secure mobile communications according to one or more aspects described herein; and

FIG. 4 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, conventional systems generate rely on cellular network to provide voice calls to mobile devices. However, cellular carriers have limited cybersecurity protections in place to detect potentially malicious calls. While, in some conventional arrangements, cellular carriers may detect some potential spam calls, the carriers have limited or no ability to mitigate damage associated with those calls.

Accordingly, as discussed herein, an internal infrastructure to intercept incoming calls to a mobile device and route the calls through an internal cybersecurity evaluation via a data network may provide improved cybersecurity and impact mitigation. The arrangements described provide for an internal system to execute on or more cybersecurity evaluation processes or tools to determine a likelihood that the call is malicious. If the call is likely malicious, it may be routed, via the data network, to an internet computing device for further analysis, intelligence gathering, and the like. If the call is not likely malicious, it may be routed to the mobile device of the intended recipient via the data network. In some examples, an application executing on the mobile device may facilitate receiving and providing the call to the mobile device using the data network.

These and various other arrangements will be discussed more fully below.

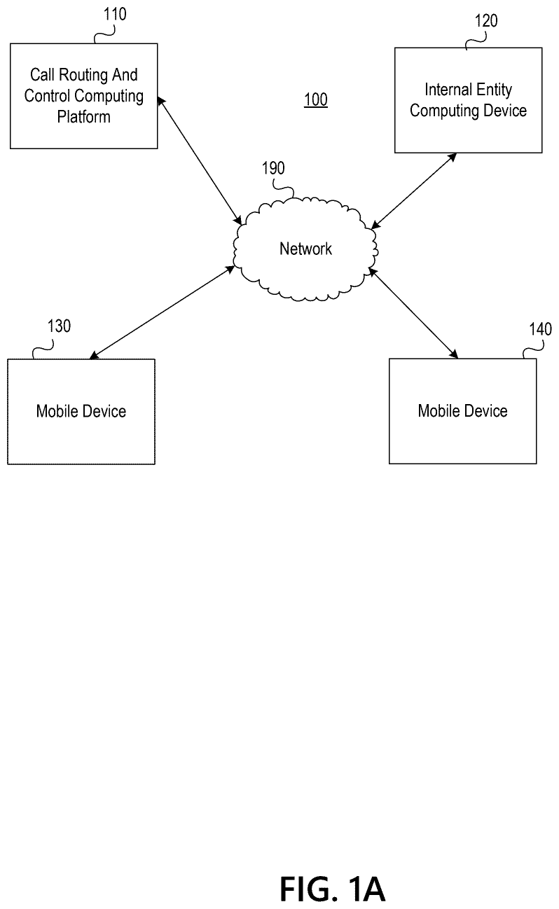

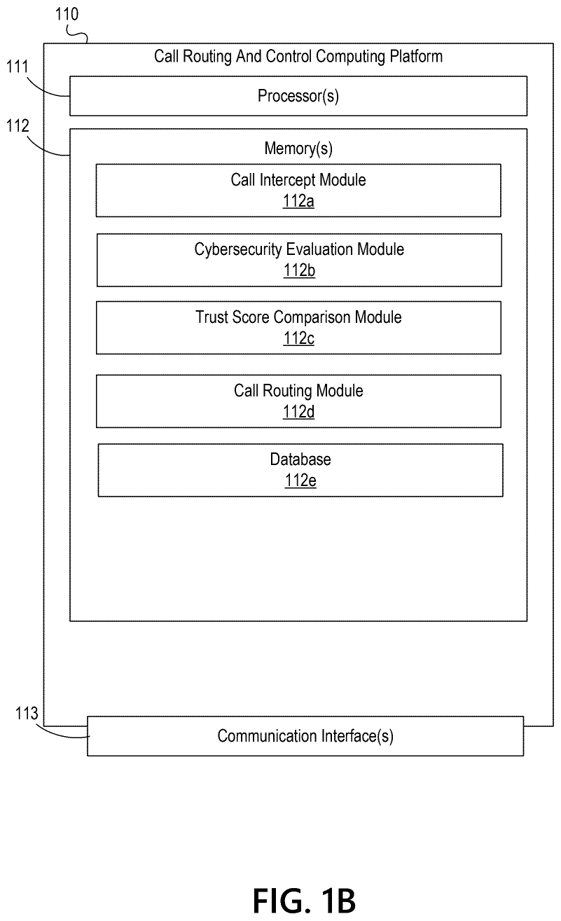

FIGS. 1A-1B depict an illustrative computing environment and devices for secure mobile communication in accordance with one or more aspects described herein. Referring to FIG. 1A, computing environment 100 may include one or more computing devices and/or other computing systems. For example, computing environment 100 may include call routing and control computing platform 110, internal entity computing device 120, mobile device 130 and mobile device 140.

Although one internal entity computing device 120 and two mobile devices 130, 140 are shown, any number of systems or devices may be used without departing from the invention.

Call routing and control computing platform 110 may be or include one or more computer components (e.g., servers, server blade, processor, memory, and the like) and may be configured to perform intelligent, dynamic, call routing and control functions. For instance, call routing and control computing platform 110 may receive an indication of an incoming call to a user mobile device, such as mobile device 130 or mobile device 140. In some examples, the call may be intercepted and routed to a wireless data network rather than a cellular network. In some examples, call routing and control computing platform 110 may provide (e.g., via download or the like) a mobile application to the mobile device 130 and/or mobile device 140 to enable interception of incoming calls, control network used to handle incoming calls, and the like.

Upon receiving the indication of the incoming call or intercepting the incoming call, call routing and control computing platform 110 may route the call to an enterprise organization cybersecurity evaluation system. In some examples, the cybersecurity evaluation system may include one or more applications, tools, or the like, to analyze or evaluate the incoming call to determine whether the incoming call is malicious or potentially malicious (e.g., a social engineering call, a spam call, or the like). In some examples, cybersecurity evaluation system may evaluate the call based on historical data (e.g., known threat actors, phone numbers associated with known threat actors, internet protocol (IP) addresses associated with known threat actors, or the like). Based on the evaluation, call routing and control computing platform 110 may determine a trust score associated with an incoming call.

In some examples, call routing and control computing platform 110 may compare the trust score to one or more thresholds to determine how to further route the call. For instance, the trust score may be compared to a first threshold and, if below that threshold, may be routed to an agent or agent device (e.g., internal entity computing device 120) for further evaluation. If at or above the first threshold, the call may be routed to the intended recipient. In other examples, two or more thresholds may be used to determine whether the call should be routed to an agent, the intended recipient and/or more information provided to the intended recipient.

Based on the comparison, call routing and control computing platform 110 may route the incoming call to the agent or the intended recipient. The outcome of the call may then be stored for further evaluation or use in analyzing future calls.

Internal entity computing device 120 may be or include one or more computing devices (e.g., laptop computers, desktop computers, mobile devices, tablet devices, or the like) that may be used by an employee, agent, associate or other user of the enterprise organization implementing the call routing and control computing platform 110. In some examples, internal entity computing device 120 may be associated with a cybersecurity analyst or agent that may receive calls for an intended recipient having a trust score below a threshold. The cybersecurity analyst or agent may, via the internal entity computing device 120, evaluate the call to determine whether it is malicious and/or gather data about the threat actor initiating the call.

Mobile device 130 and/or mobile device 140 may be or include one or more mobile computing devices (e.g., smart phones, wearable devices, tablet devices, or the like) that may be configured to communicate (e.g., via call, short messaging service (SMS), or the like) via a cellular network and a wireless data network. Mobile device 130 and/or mobile device 140 may include an application executing on a respective device that may be configured to prioritize a network being used for receiving calls (e.g., prioritize a wireless data network over a cellular network), provide calls to the user, display one or more notifications, and the like.

As mentioned above, computing environment 100 also may include one or more networks, which may interconnect one or more of call routing and control computing platform 110, internal entity computing device 120, mobile device 130 and/or mobile device 140. For example, computing environment 100 may include network 190. Network 190 may, in some examples, be a private network and include one or more sub-networks (e.g., Local Area Networks (LANs), Wide Area Networks (WANs), or the like). Network 190 may interconnect one or more computing devices associated with the organization. For example, call routing and control computing platform 110, internal entity computing device 120, mobile device 130 and/or mobile device 140 may be connected via network 190.

Referring to FIG. 1B, call routing and control computing platform 110 may include one or more processors 111, memory 112, and communication interface 113. A data bus may interconnect processor(s) 111, memory 112, and communication interface 113. Communication interface 113 may be a network interface configured to support communication between call routing and control computing platform 110 and one or more networks (e.g., network 190, or the like). Memory 112 may include one or more program modules having instructions that when executed by processor(s) 111 cause call routing and control computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of call routing and control computing platform 110 and/or by different computing devices that may form and/or otherwise make up call routing and control computing platform 110.

For example, memory 112 may have, store and/or include call intercept module 112a. Call intercept module 112a may store instructions and/or data that may cause or enable the call routing and control computing platform 110 to receive an indication of or intercept an incoming call to a user device, such as mobile device 130, mobile device 140, or the like. In some examples, intercepting the call and/or providing the indication may be performed by an application executing on the mobile device 130 or mobile device 140 (e.g., an enterprise organization application for routing calls provided by the enterprise organization). In some examples, call intercept module 112a may cause the call to be handled by a wireless data network rather than a cellular network to enable cybersecurity evaluation as described herein.

Call routing and control computing platform 110 may further have, store and/or include cybersecurity evaluation module 112b. Cybersecurity evaluation module 112b may store instructions and/or data that may cause or enable the call routing and control computing platform 110 to route the intercepted call (e.g., via a wireless data network such as network 190) to cybersecurity evaluation module 112b for evaluation or analysis. For instance, one or more applications or tools may be executed by the cybersecurity evaluation module 112b (and/or systems, devices or the like in communication with the cybersecurity evaluation module 112b) to identify or determine a trust score associated with the call. In some examples, cybersecurity evaluation module 112b may compare call details, such as number from which the call is received, IP address from which the call is received, user identifier associated with the call, or the like, to known threat actors to determine or identify a trust score of the call. In some examples, the trust score may indicate a likelihood that the call is not malicious or not a cybersecurity threat (e.g., a higher score may indicate the call is less likely to be malicious, while a low score may indicate the call is likely malicious).

In some examples, the trust score may be determined by providing a value for each call detail being compared. When a match occurs, a value of zero (0) may be assigned and if a match does not occur for a particular call detail, a value of one (1) may be assigned. The value for all call details may be summed to determine an overall trust score for the incoming call.

The above example for determining the trust score is merely one example and other processes for determining a trust score for the incoming call may be used without departing from the invention.

In some examples, filtering of one or more calls may be performed based on trust score. For instance, if the trust score is below a second threshold (e.g., the score is so low that it is almost certainly malicious), in some examples, the call may be filtered out and dropped or otherwise disconnected to focus resources on calls having less surety of content.

Call routing and control computing platform 110 may further have, store and/or include trust score comparison module 112c. Trust score comparison module 112c may store instructions and/or data that may cause or enable the call routing and control computing platform 110 to compare a trust score for an incoming call to one or more thresholds. If the trust score is below the threshold, the call may be routed, such as by call routing module 112d) to an agent or agent device, such as internal entity computing device 120, for further evaluation and/or data collection associated with the threat actor. If the trust score meets or exceeds the threshold, the call may be routed, by the call routing module 112d, to the intended recipient. In some examples, the threshold may be customized by the enterprise organization.

Call routing module 112d may store instructions and/or data that may cause or enable the call routing and control computing platform 110 to route an incoming call to a particular user or device based on a comparison of the trust score for that call to a threshold. In some examples, call routing module 112d may also generate, send and/or cause to display one or more notifications indicating a trust score or user-friendly representation of the identified trust score for a particular call.

Call routing and control computing platform 110 may further have, store and/or include a database 112e. Database 112e may store data related to known threat actors, malicious phone numbers or other historical call data, determine trust scores, and/or other data to perform the functions of the call routing and control computing platform 110.

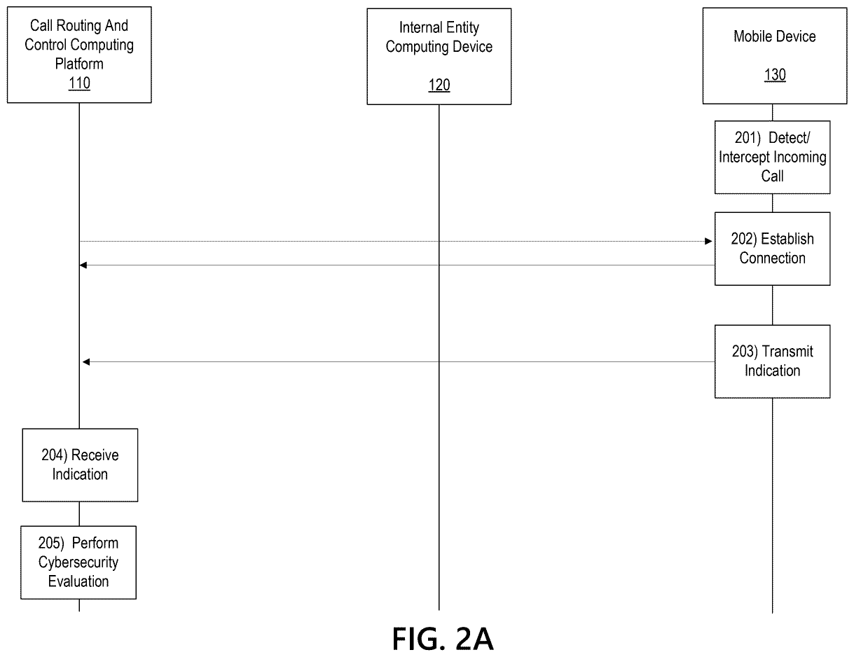

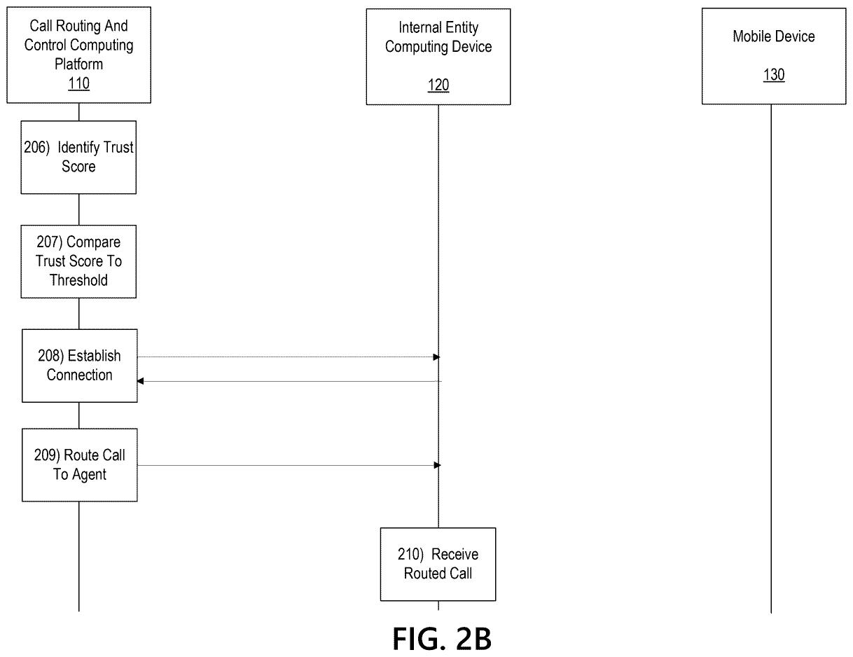

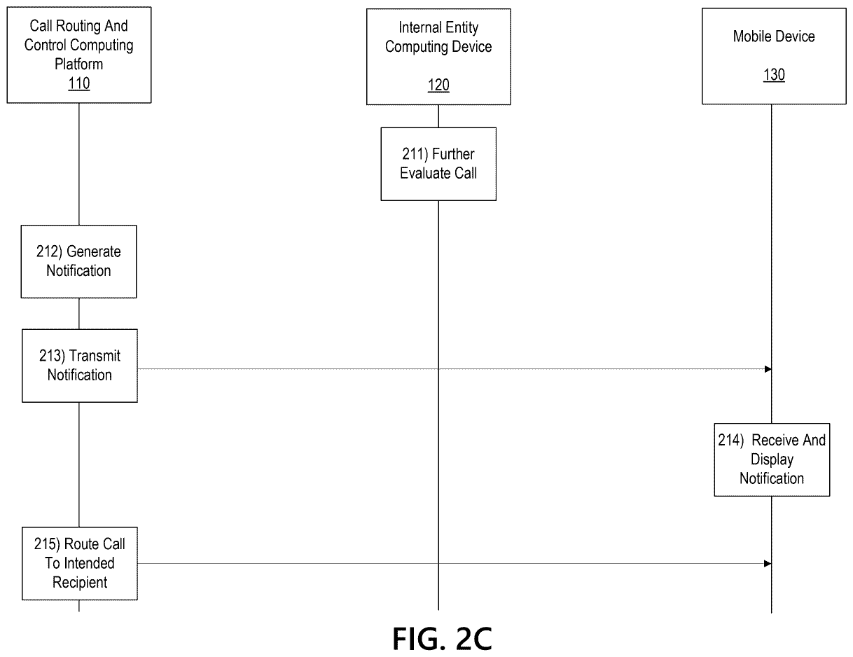

FIGS. 2A-2C depict one example illustrative event sequence for secure mobile communications in accordance with one or more aspects described herein. The events shown in the illustrative event sequence are merely one example sequence and additional events may be added, or events may be omitted, without departing from the invention. Further, one or more processes discussed with respect to FIGS. 2A-2E may be performed in real-time or near real-time.

With reference to FIG. 2A, at step 201, a mobile device of a user, such as mobile device 130, may detect an incoming call. In some examples, detecting the incoming call may include intercepting, by an application executing on the mobile device, the incoming call. In some examples, intercepting the incoming call may include prioritizing a wireless data network for handling the call over a cellular network. For instance, the call may be received by the application executing on the mobile device via a wireless data network, such as network 190, and transmitted for evaluation via the wireless data network. Accordingly, a cellular carrier might not be in involved in the cybersecurity evaluation of the incoming call.

At step 202, mobile device 130 may establish a wireless data connection with call routing and control computing platform 110. For instance, mobile device 130 may establish a first wireless data connection with call routing and control computing platform 110. Upon establishing the first wireless data connection, a communication session may be initiated between call routing and control computing platform 110 and mobile device 130.

At step 203, mobile device 130 (e.g., via the application executing on the mobile device) may transmit an indication that the call was intercepted. In some examples, transmitting the indication may include transmitting call details such as a number from which the call was received, IP address associated with the call, user identification associated with the call, and the like.

At step 204, call routing and control computing platform 110 may receive the indication transmitted or sent at step 203.

At step 205, the call routing and control computing platform 110 may execute one or more cybersecurity evaluations on the intercepted call. For instance, call details associated with the intercepted call may be compared to historical call details associated with threat actors or malicious calls to determine whether the incoming call is malicious or potentially malicious. In some examples, one or more applications or tools may be executed to evaluate the call and call details.

With reference to FIG. 2B, at step 206, call routing and control computing platform 110 may identify or determine a trust score associated with the call. For instance, features of the call (e.g., number from which call is received, IP address associated with call, or the like) may be compared to known malicious actors or calls. Based on the comparing, a trust score indicating a likelihood that the call is malicious may be determined or identified.

At step 207, call routing and control computing platform 110 may compare the determined trust score to one or more thresholds. If, at step 207, the all is at or above the trust score threshold (e.g., the call is likely not malicious), the process may proceed to step 212 in FIG. 2C.

If, at step 207, the trust score is below the threshold (e.g., the trust score indicates the call is likely malicious), at step 208, call routing and control computing platform 110 may establish a wireless data connection with internal entity computing device 120. For instance, call routing and control computing platform 110 may establish a second wireless data connection with internal entity computing device 120. Upon establishing the second wireless data connection, a communication session may be initiated between call routing and control computing platform 110 and internal entity computing device 120.

At step 209, call routing and control computing platform 110 may route or transfer the incoming call to the internal entity computing device 120 for further evaluation or analysis. For instance, call routing and control computing platform 110 may transfer or route the call, via the communication session initiated upon establishing the second wireless data connection, to the internal entity computing device 120. In some examples, an agent or associate operating the internal entity computing device 120 may engage with the caller to gather intelligence related to the call which may be used to analyze subsequent incoming calls.

At step 210, the internal entity computing device 120 may receive the routed call.

With reference to FIG. 2C, at step 211, the agent or associate may further evaluate or analyze the call (e.g., via internal entity computing device 120) to determine whether the call is, in fact, malicious, gather intelligence, and the like.

At step 212, if the trust score is at or above the threshold, or after transferring the incoming call to the internal entity computing device 120, call routing and control computing platform 110 may generate a notification. For instance, if the trust score is at or above the threshold, a notification including the trust score or a user-friendly indication that the call is likely not malicious may be generated. If the call was routed to the internal entity computing device 120, the notification may indicate that an incoming call was received for the user but that the call was deemed likely malicious and is being evaluated further.

At step 213, call routing and control computing platform 110 may transmit or send the notification to the mobile device 130. In some examples, transmitting or sending the notification may cause the notification to be displayed by a display of the mobile device 130.

At step 214, the mobile device 130 may receive and display the notification.

At step 215, call routing and control computing platform 110 may, based on determining that the trust score is at or above the threshold and, therefore, the incoming call is likely not malicious, may route or transfer the call to the mobile device 130. In some examples, routing the call to the mobile device 130 may include an option to accept or decline the call.

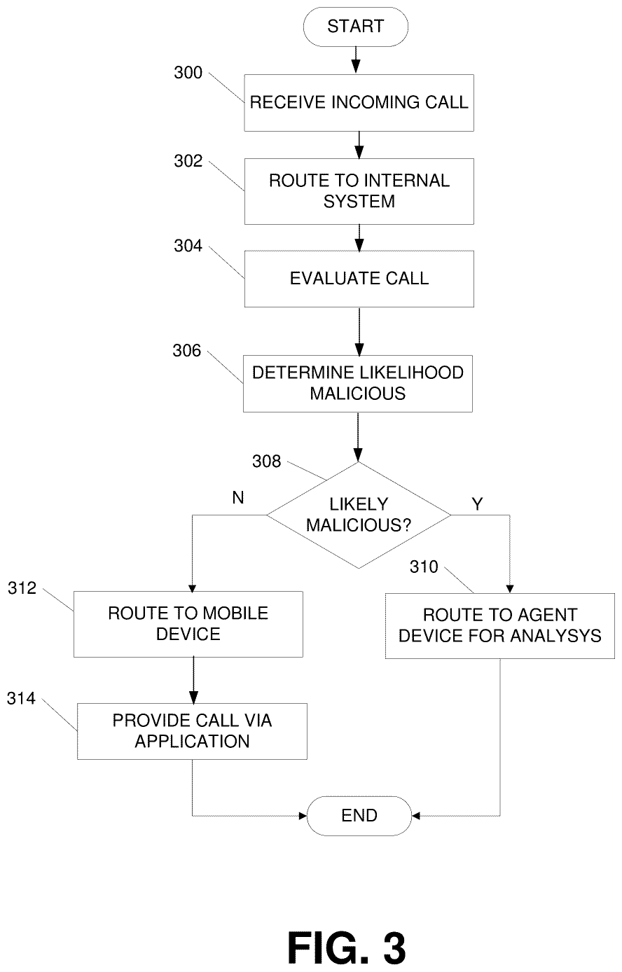

FIG. 3 is a flow chart illustrating one example method for secure mobile communications in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, call routing and control computing platform 110 may receive an indication of an incoming call to a mobile device 130 of a user. In some examples, the mobile device 130 may have and/or be executing an application configured to route and control calls associated with an enterprise organization associated with the call routing and control computing platform 110, such as an employer of the user of the mobile device 130. In some arrangements, the application may be provided to the mobile device 130 (e.g., via download) prior to the indication of the incoming call.

At step 302, the call routing and control computing platform 110 may route the call to an internal cybersecurity evaluation system via a wireless data network. For instance, in some examples, the call may be routed for further evaluation via a wireless data network, rather than a cellular network. Accordingly, evaluation of the call for malicious aspects may be performed by the cybersecurity system internal to the enterprise organization, which may provide more robust analysis, than evaluation provided by a cellular service carrier. Accordingly, once the call is routed for evaluation, the call may be handled (e.g., routed to the intended recipient, routed to an agent device, or the like) via the data network, rather than the cellular network. In some examples, the mobile device might not have cellular calling capability and, instead, may rely on a data network for communication.

At step 304, the call routing and control computing platform 110 may evaluate the call using one or more cybersecurity evaluation tools. For instance, call routing and control computing platform may use one or more cybersecurity applications or tools to evaluate details of the incoming call to determine whether it is likely malicious. In some examples, call details may be compared to call details of known malicious calls to determine whether the incoming call is likely malicious. In some examples, a trust score may be determined for the incoming call. For example, call details may be analyzed and scored to determine an overall trust score that indicates a likelihood the incoming call is malicious.

At step 306, based on the evaluation of the call and, in some examples, identified trust score, the call routing and control computing platform 110 may determine a likelihood that the call is malicious. In some examples, that may include comparing the trust score to a threshold to determine whether the score meets or exceeds the threshold (not likely malicious) or fails to meet the threshold (likely malicious).

At step 308, the call routing and control computing platform 110 may determine whether the call is identified as likely malicious. If so, at step 310, the call may be routed or transferred to a computing device associated with an agent of the enterprise organization (e.g., internal entity computing device 120) for further analysis, intelligence gathering, and the like.

If, at step 308, the call is not likely malicious, at step 312, the call routing and control computing platform 110 may route the call to the mobile device 130 of the intended recipient. In some examples, routing the call may include generating a notification including, for example, the trust score associated with the call and, in some examples, including an option to accept or reject the call. The notification may be transmitted to the mobile device and displayed by a display of the mobile device (e.g., via the application executing on the mobile device 130). The call may be routed to the mobile device 130 using the wireless data network (e.g., rather than a cellular network). In some examples, routing the call to the mobile device 130 may include disabling (e.g., via the application executing on the mobile device) cellular service to the mobile device 130 in favor of or to prioritize use of the wireless data network to route the call.

At step 314, the call routing and control computing platform 110 may provide the call to the mobile device 130 via the application executing on the mobile device 130 and using the wireless data network.

Accordingly, aspects described herein provide secure mobile communications by providing an internal infrastructure to evaluate incoming mobile calls for potentially malicious activity and route the calls based on a likelihood of malicious activity. In particular, these arrangements may be useful to ensure that employees of an enterprise organization, who use mobile devices to conduct enterprise business, are protected from spam calls, social engineering calls, deep fake calls, and the like.

For instance, threat actors may initiate a call to a user mobile device and may use deep fake technology and/or social engineering techniques to encourage users or employees of the enterprise to divulge personal and/or confidential information. Calls of this nature can have an enormous impact on security for the enterprise. Accordingly, by providing an internal infrastructure for evaluating calls for potential malicious activity, rather than relying on the cellular carrier, the arrangements described herein more accurately identify potentially malicious activity and mitigate impact by routing calls to agents or associates for further evaluation.

As discussed herein, a mobile application associated with the enterprise organization may be executing on the mobile device of the user and may provide an indication of the incoming call to the computing platform and/or may aid in routing the call to the computing platform for analysis. In some examples, this application may generally execute in the background. However, in some arrangements, the application may used to provide notifications, provide a call deemed likely not malicious, and the like. In some examples, the mobile application may disable or de-prioritize a cellular network in favor of a wireless data network to route the call, analyze the call, transfer the call to one or more devices, or the like. In some examples, a voice plan or voice-based cellular service might not be provided on the mobile device and all activity may be executed via the wireless data network.

While various aspects described are described in the context of incoming calls, in some arrangements, outgoing calls may also be executed via the application executing on the mobile device (e.g., using the wireless data network rather than a cellular network).

Further, the arrangements provided herein may provide improved location-based services associated with a mobile device. For instance, in conventional arrangements, location data is based on global positioning system (GPS) data. When a user device is in, for instance, a high-rise office building, that GPS data might not be accurate with respect to a precise location of the user. Accordingly, the arrangements described herein may provide improved location accuracy because the mobile device may be connected to a wireless data network that may provide additional accuracy (e.g., based on wireless LAN, media access control (MAC) identifier, or the like) with respect to a location (e.g., a particular floor of the building, an office location, a section of a floor, or the like). Accordingly, in emergency situations the arrangements described may provide improved location services associated with the mobile device.

Further, even in arrangements in which a mobile device does not have cellular service, emergency calls may still be executed by the device (e.g., via wireless network, or the like). In examples in which the mobile device only has data service (e.g., does not have a voice plan) emergency calls may still be made using cellular as needed.

The arrangements described further enable single number for connectivity with a user because the user may transition from an office phone line to a mobile phone line seamlessly (e.g., via the application executing on the mobile device).

The arrangements described may also enable use of features such as call recording via internal infrastructure, rather than relying on cellular network or carrier. Accordingly, all data associated with the recording or call may be held within the enterprise organization, which may further reduce security risk.

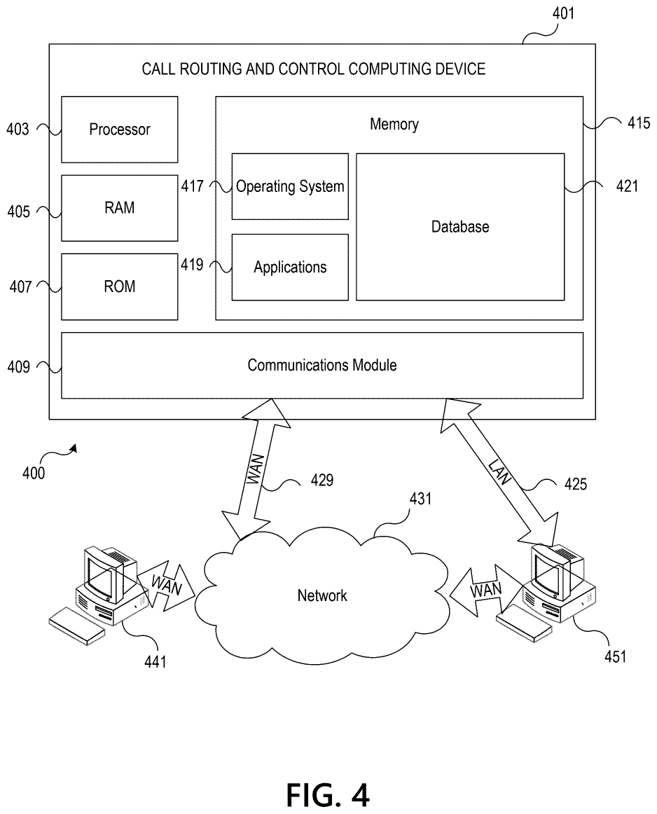

FIG. 4 depicts an illustrative operating environment in which various aspects of the present disclosure may be implemented in accordance with one or more example embodiments. Referring to FIG. 4, computing system environment 400 may be used according to one or more illustrative embodiments. Computing system environment 400 is only one example of a suitable computing environment and is not intended to suggest any limitation as to the scope of use or functionality contained in the disclosure. Computing system environment 400 should not be interpreted as having any dependency or requirement relating to any one or combination of components shown in illustrative computing system environment 400.

Computing system environment 400 may include call routing and control computing device 401 having processor 403 for controlling overall operation of call routing and control computing device 401 and its associated components, including Random Access Memory (RAM) 405, Read-Only Memory (ROM) 407, communications module 409, and memory 415. Call routing and control computing device 401 may include a variety of computer readable media. Computer readable media may be any available media that may be accessed by call routing and control computing device 401, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by call routing and control computing device 401.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor (e.g., hardware processor) on call routing and control computing device 401. Such a processor may execute computer-executable instructions stored on a computer-readable medium.

Software may be stored within memory 415 and/or storage to provide instructions to processor 403 for enabling call routing and control computing device 401 to perform various functions as discussed herein. For example, memory 415 may store software used by call routing and control computing device 401, such as operating system 417, application programs 419, and associated database 421. Also, some or all of the computer executable instructions for call routing and control computing device 401 may be embodied in hardware or firmware. Although not shown, RAM 405 may include one or more applications representing the application data stored in RAM 405 while call routing and control computing device 401 is on and corresponding software applications (e.g., software tasks) are running on call routing and control computing device 401.

Communications module 409 may include a microphone, keypad, touch screen, and/or stylus through which a user of call routing and control computing device 401 may provide input, and may also include one or more of a speaker for providing audio output and a video display device for providing textual, audiovisual and/or graphical output. Computing system environment 400 may also include optical scanners (not shown).

Call routing and control computing device 401 may operate in a networked environment supporting connections to one or more remote computing devices, such as computing devices 441 and 451. Computing devices 441 and 451 may be personal computing devices or servers that include any or all of the elements described above relative to call routing and control computing device 401.

The network connections depicted in FIG. 4 may include Local Area Network (LAN) 425 and Wide Area Network (WAN) 429, as well as other networks. When used in a LAN networking environment, call routing and control computing device 401 may be connected to LAN 425 through a network interface or adapter in communications module 409. When used in a WAN networking environment, call routing and control computing device 401 may include a modem in communications module 409 or other means for establishing communications over WAN 429, such as network 431 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive an indication of an incoming call to a mobile device of an intended recipient;
route the incoming call to an internal cybersecurity evaluation system via a wireless data network;
evaluate the incoming call using one or more cybersecurity evaluation tools;
determine, based on the evaluation, a likelihood that the incoming call is malicious;
responsive to determining, based on the likelihood, that the incoming call is likely malicious, route the incoming call to a first agent computing device for further analysis;
responsive to determining, based on the likelihood, that the incoming call is not likely malicious, route the incoming call to the mobile device of the intended recipient via the data network; and
provide, via an application executing on the mobile device of the intended recipient, the incoming call to the intended recipient.

2. The computing platform of claim 1, wherein determining, based on the evaluation, a likelihood that the incoming call is malicious includes determining a trust score for the incoming call.

3. The computing platform of claim 2, further including instructions that, when executed, cause the computing platform to:
compare the trust score to a threshold;
responsive to determining that the trust score meets or exceeds the threshold, determine that the incoming call is not likely malicious; and
responsive to determining that the trust score is below the threshold, determine that the incoming call is likely malicious.

4. The computing platform of claim 2, further including instructions that, when executed, cause the computing platform to:
generate a notification including the trust score; and
transmit the notification to the mobile device of the intended recipient prior to routing the incoming call to the mobile device of the intended recipient, wherein transmitting the notification causes the mobile device of the intended recipient to display the notification on a display of the mobile device of the intended recipient.

5. The computing platform of claim 4, wherein the notification includes an option to accept or reject the incoming call based on the trust score.

6. The computing platform of claim 1, further including instructions that, when executed, cause the computing platform to:
provide, to the mobile device of the intended recipient and prior to receiving the indication of the incoming call, the application to the mobile device of the intended recipient, wherein the application intercepts the incoming call and provides the indication of the incoming call to the computing platform.

7. The computing platform of claim 1, further including instructions that, when executed, cause the computing platform to:
disable access to a cellular network on the mobile device of the intended recipient; and
route calls to the mobile device of the intended recipient using the wireless data network via the application executing on the mobile device of the intended recipient.

8. A method, comprising:
receiving, by a computing platform, the computing platform having at least one processor, and memory, an indication of an incoming call to a mobile device of an intended recipient;
routing, by the at least one processor, the incoming call to an internal cybersecurity evaluation system via a wireless data network;
evaluating, by the at least one processor, the incoming call using one or more cybersecurity evaluation tools;
determining, by the at least one processor and based on the evaluation, a likelihood that the incoming call is malicious;
responsive to determining, based on the likelihood, that the incoming call is likely malicious, routing, by the at least one processor, the incoming call to a first agent computing device for further analysis;
responsive to determining, based on the likelihood, that the incoming call is not likely malicious, routing, by the at least one processor, the incoming call to the mobile device of the intended recipient via the wireless data network; and
providing, by the at least one processor and via an application executing on the mobile device of the intended recipient, the incoming call to the intended recipient.

9. The method of claim 8, wherein determining, based on the evaluation, a likelihood that the incoming call is malicious includes determining a trust score for the incoming call.

10. The method of claim 9, further including:
comparing, by the at least one processor, the trust score to a threshold;
responsive to determining that the trust score meets or exceeds the threshold, determining, by the at least one processor, that the incoming call is not likely malicious; and
responsive to determining that the trust score is below the threshold, determining, by the at least one processor, that the incoming call is likely malicious.

11. The method of claim 9, further including:
generating, by the at least one processor, a notification including the trust score; and
transmitting, by the at least one processor, the notification to the mobile device of the intended recipient prior to routing the incoming call to the mobile device of the intended recipient, wherein transmitting the notification causes the mobile device of the intended recipient to display the notification on a display of the mobile device of the intended recipient.

12. The method of claim 11, wherein the notification includes an option to accept or reject the incoming call based on the trust score.

13. The method of claim 8, further including:
providing, by the at least one processor and to the mobile device of the intended recipient and prior to receiving the indication of the incoming call, the application to the mobile device of the intended recipient, wherein the application intercepts the incoming call and provides the indication of the incoming call to the computing platform.

14. The method of claim 8, further including:
disabling, by the at least one processor, access to a cellular network on the mobile device of the intended recipient; and
routing, by the at least one processor, calls to the mobile device of the intended recipient using the wireless data network via the application executing on the mobile device of the intended recipient.

15. One or more non-transitory computer-readable media storing instructions that, when executed by a computing platform comprising at least one processor, memory, and a communication interface, cause the computing platform to:
receive an indication of an incoming call to a mobile device of an intended recipient;
route the incoming call to an internal cybersecurity evaluation system via a wireless data network;
evaluate the incoming call using one or more cybersecurity evaluation tools;
determine, based on the evaluation, a likelihood that the incoming call is malicious;
responsive to determining, based on the likelihood, that the incoming call is likely malicious, route the incoming call to a first agent computing device for further analysis;
responsive to determining, based on the likelihood, that the incoming call is not likely malicious, route the incoming call to the mobile device of the intended recipient via the wireless data network; and
provide, via an application executing on the mobile device of the intended recipient, the incoming call to the intended recipient.

16. The one or more non-transitory computer-readable media of claim 15, wherein determining, based on the evaluation, a likelihood that the incoming call is malicious includes determining a trust score for the incoming call.

17. The one or more non-transitory computer-readable media of claim 16, further including instructions that, when executed, cause the computing platform to:
compare the trust score to a threshold;
responsive to determining that the trust score meets or exceeds the threshold, determine that the incoming call is not likely malicious; and
responsive to determining that the trust score is below the threshold, determine that the incoming call is likely malicious.

18. The one or more non-transitory computer-readable media of claim 16, further including instructions that, when executed, cause the computing platform to:
generate a notification including the trust score; and
transmit the notification to the mobile device of the intended recipient prior to routing the incoming call to the mobile device of the intended recipient, wherein transmitting the notification causes the mobile device of the intended recipient to display the notification on a display of the mobile device of the intended recipient.

19. The one or more non-transitory computer-readable media of claim 15, further including instructions that, when executed, cause the computing platform to:
provide, to the mobile device of the intended recipient and prior to receiving the indication of the incoming call, the application to the mobile device of the intended recipient, wherein the application intercepts the incoming call and provides the indication of the incoming call to the computing platform.

20. The one or more non-transitory computer-readable media of claim 15, further including instructions that, when executed, cause the computing platform to:
disable access to a cellular network on the mobile device of the intended recipient; and
route calls to the mobile device of the intended recipient using the wireless data network via the application executing on the mobile device of the intended recipient.
